(19) United States
(12) Patent Application Publication
(10) Pub. No.: US 2023/0068694 A1
(43) Pub. Date: Mar. 2, 2023

(54) Method and System for Planning and Monitoring the Progress of Construction Projects

(71) Applicant: Build Trust S.R.L, Minerbe (IT)

(72) Inventor: Federico Furlani, Minerbe (IT)

(21) Appl. No.: 17/797,028

(22) PCT Filed: Feb. 3, 2021
(86) PCT No.: PCT/EP2021/052578

§ 371 Date: Aug. 2, 2022

(30) Foreign Application Priority Data
Feb. 4, 2020 (IT) 102020000002185

(51) Int. Cl. G06Q 10/10; G06Q 20/40; G06Q 20/38

(52) U.S. Cl. CPC G06Q 10/103; G06Q 20/40; G06Q 20/389

(57) ABSTRACT

Method and system for the design, execution and monitoring of works, particularly in the construction field, through the modeling of projects by means of a BIM system integrated with the construction engineering necessary to configure all the systems and equipment required for construction. loT and/or Blockchain technologies are combined with conventional BIM systems for more precise monitoring and traceability of the stages in construction. The system and method according to a preferred embodiment of the present invention use the information collected by a plurality of detectors. The plurality of detectors preferably includes loT devices. Detectors can be associated with any machinery used for the project and may include, for example, image acquisition devices such as cameras, remote cameras or web-cams fixed or mounted on drones; other possible detectors may be worn by construction staff. Detectors may also receive information from meteorological and/or seismographic services for a geographical area linked to at least one project.

### TECHNICAL FIELD

The present invention relates to a method and system for planning and monitoring the phases of a construction project, more specifically a method and system for managing projects in the field of construction, following their progress over time, through the use of loT devices.

### PRIOR ART

The design, implementation and control of the execution of major works (e.g. in the construction sector) involves management of complexity that is only partly assisted by modern integrated data processing systems. So-called BIM (Building Information Modeling) systems are revolutionizing the civil engineering sector, incorporating sets of information organized in databases that are becoming increasingly integrated into the design of construction works. There is no single or internationally recognized definition of BIM, although attempts are under way to develop a standard definition accepted by many operators and possibly regulated by law. At the least, BIM means an integrated structure of systems and software that enables the elements of a project for works to be represented digitally, mainly in the construction field (e.g. buildings, bridges, dams, roads, industrial plants), with the aim of helping and facilitating the design, construction and control of the works and related decisions.

As a rule, the planning of a construction project developed with a BIM system becomes difficult to check when the work is under way because it relies on monitoring the stages in progress through the work of people, professionals, project managers, inspectors, etc., who confirm whether the work envisaged in the BIM has actually been performed or not. At present there is no digital certification for this information and, even less so, for contracting linked to this monitoring that can ensure compliance with the terms of supply. What is lacking is a structured modeling approach that, in addition to collecting data, analyses it in detail symmetrically with the BIM model, monitoring time, costs and quality, as well as compliance with site safety and environmental regulations, in real time, in digital mode, generating a database of information.

The object of the present invention is to provide technology that at least partly overcomes the disadvantages of currently available systems.

### SUMMARY OF THE INVENTION

According to the present invention we provide a method for managing and monitoring the execution of at least one project comprising a plurality of activities, by means of a distributed system comprising a plurality of detectors connected with a server, each of the plurality of detectors being adapted to measure at least one operating parameter related to one of the plurality of activities and to transmit the value of the at least one measured operating parameter at predetermined time intervals to the server, the method comprising the steps of: maintaining, for each project, in a database accessible from the server, a smart contract defining a list of activities, each activity having a plurality of associated operating parameters and for each associated operating parameter an expected value based on the time elapsed since the beginning of the activity, the smart contract defining the payments to be authorized when the expected values are reached, each of the operating parameters being associated with at least one of the plurality of sensors; processing, in a traceable and secure way, by the server the values of the parameters received from the plurality of sensors and calculating for each parameter a deviation from the expected value; determining by the server a value representative of the total deviation with respect to the plurality of expected values; responsive to a predetermined threshold being exceeded by the value representative of the total deviation, executing a predetermined corrective action procedure, or responsive to the predetermined threshold not being exceeded by the value representative of the total deviation, authorizing the payment associated to the expected values.

In a preferred embodiment, the method is based on a Building Information Modeling (BIM) system and is preferably integrated with a Blockchain for the traceable and unmodifiable management of the progress steps of the project and integration with the financial aspects of the project. Preferably, the server and/or at least one of the detectors are connected and exchange information in a traceable and secure way by means of a Blockchain system. In a preferred embodiment of the present invention, the smart contract defines at least one milestone associated to each of the plurality of activities, each milestone being associated to at least one financial transaction, and the method further comprises: monitoring the real time progress of the plurality of activities to determine whether a milestone is reached; responsive to a milestone being reached, authorizing the at least one associated financial transaction. The plurality of detectors preferably comprises loT devices. The detectors can be associated to any device used for performing the project and can include for example image acquisition devices, such as cameras, video-cameras, webcams, possibly installed on a drone; other possible devices include personal wearable devices used by the workers on the project sites. It is also possible that the detectors receive information from device capable of providing meteorological and/or seismographic information of a geographical area linked to the at least one project.

According to the present invention we also provide a computer program, an application software or a program product, adapted to perform a method for managing and monitoring the execution of at least one project comprising a plurality of activities, according to the method described above, when the program is executed on a computer, a smartphone or any other data processing system.

We also provide a distributed system comprising one or more components suitable for implementing a method for managing and monitoring the execution of at least one project comprising a plurality of activities, as described above.

With the present invention it is possible to implement a system which combines existing BIM tools with advanced technologies, such as for example loT (Internet of Things) to realize a digital platform which is able to monitor and control the sustainability and the actual execution of intended project as defined in BIM system. In a preferred embodiment of the present invention, the Blockchai technology is used to trace and guarantee all the financial transactions in a safe and certified way.

### BRIEF DESCRIPTION OF THE FIGURES

These and further advantages, objects and features of the present invention will be better understood by a person skilled in the art from the following description and the attached drawings relating to examples of embodiments of an illustrative nature, that are not to be understood in a limiting sense, in which:

FIG. 1 illustrates the general architecture of a system according to a preferred embodiment of the present invention;

FIG. 2 shows diagrammatically a generic computer used in the system according to a preferred embodiment of the present invention;

FIG. 3 illustrates diagrammatically a management model according to the present invention;

FIGS. 4, 5 and 6 show examples of digital representations of a project site;

FIG. 7 illustrates a scheme for the architecture of an embodiment of the present invention, based on eight conceptual nodes;

FIG. 8 is a different illustration of the model in FIG. 1 with of the eight nodes architecture of FIG. 7;

FIG. 9 shows illustrative graphs generated by a system according to a preferred embodiment of the present invention;

FIG. 10 illustrates diagrammatically the steps of a method according to a preferred embodiment of the present invention.

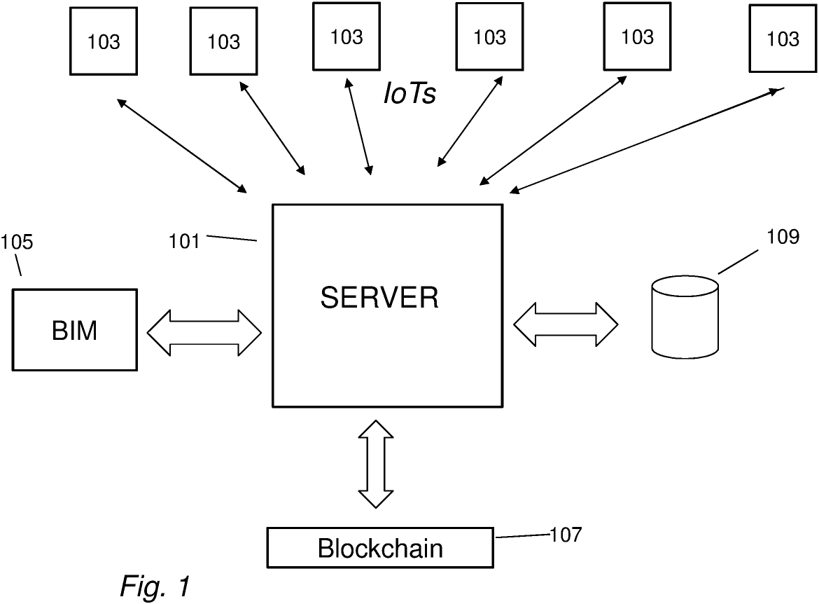

### DETAILED DESCRIPTION OF EMBODIMENTS OF THE INVENTION

In accordance with the method and system according to the present invention, the objective of keeping the performance and progress of a project for works (e.g. a large construction project) under control is fulfilled by collecting data from the automatic systems and sensors on board all plant, equipment and resources contributing to the construction work, such as, for example, plant for the production of concrete, machines for the processing of reinforcing and structural steels, earthmoving machines, cranes and various items of lifting equipment, means for the transport of raw materials and components, and also the human resources working in the context of the construction site (through, for example, wearable devices).

An additional possible source for the collection of data and the monitoring of progress is the use of scans of images generated by drones and digital photo-video systems, which can be superimposed on the progress simulations provided by the BIM system.

According to a preferred embodiment, an additional source of data can come from weather and seismographic sites to check the compatibility of the environmental conditions with performance of the site works. In a preliminary phase, all these data are incorporated into the platform symmetrically with respect to what is envisaged in the BIM in order to validate the hypothetical times and costs envisaged in the BIM for performance of the work.

Once the project is under way, the system can be used to monitor the actual progress of the work, compliance with envisaged technical specifications, and any non-conformities in terms of both quality and safety and environment, in real time and digitally, collecting data from all the connected systems.

The possibility of sharing this data (e.g. through a cloud system and/or within a Blockchain) makes it possible for basic information to be distributed to all stakeholders involved in the project, for example, but not only, clients, financiers, company designers, managers and end users, so that everyone can manage their resources in an appropriate, timely and guaranteed way. The possibility of incorporating this platform into a private Blockchain then enables smart-contracts to be developed with all the technical, financial and, if desired, political and social sectors involved in a project. This is a key element for the success of the solution, enabling the real time project tracking and transparency for all the stakeholders according to the bid. The solution allows to manage and mitigate risks as well as increase quality and safety.

With a system according to a preferred embodiment of the present invention, it is possible to create a technological platform, mainly aimed at operators in the construction sector, to:
a. objectively assess the feasibility of projects within the envisaged time frame and budget;
b. monitor the actual progress of the work in real time through digital surveys;
c. share all information in a Blockchain which is accessible to all stakeholders in a profiled way;
d. develop smart-contracts linked to the information validated by the Blockchain;
e. connect the financing, securities and financial guarantees provided for the work to the validation and subsequent monitoring ensured by the system, for assuring payments through automation of smart contracts.

The desired result is to ensure compliance with the programmes and budgets of projects that are currently almost always disregarded, in order to “redeem” the construction sector from its state of unreliability as typically perceived by much of public opinion all over the world. With a system according to a preferred embodiment of the present invention, all information in the entire value chain of the Construction Industry are made available on a permissioned Blockchain, thus unleashing a huge number of use cases and applications ranging from real-time project control and monitoring, instant quantity production and quality control tracking, real-time financial tracking, payment and transaction transparency, to worker and community safety and overall project sustainability. This will significantly improve the overall efficiency and effectiveness of the entire industry for all. In this way all the participants of the Construction Ecosystem will have access to a trusted and immutable source of information that they individually and collectively need to successfully execute and complete their obligations.

The system according to a preferred embodiment of the present invention includes at least one distributed Local Infrastructure (there may also be more than one; for example, several construction sites forming part of the same major work) for the collection of information and a Central Infrastructure for processing and evaluating the information received by the Local Infrastructure. The Central Infrastructure is managed by a server 101 that controls and is connected to a number of detectors 103 set up to measure various activities. These detectors 103 include, for example, sensors and equipment for acquiring and monitoring construction plant, specific control systems present in individual machines and plant, and have the function of acquiring real-time measurements of various process and operating parameters and the status of plant/machinery. Detectors 103 may also include wearable devices (wearable computers) associated with individuals or groups of operators involved in a particular function. Another possible option according to one embodiment of the present invention is to acquire information through images and films captured by appropriate devices (in this case detectors 103 may for example be cameras, remote cameras, web-cams) that are fixed or even better mounted on drones flying over the site or production/industrial site being monitored. In addition, detectors 103 may provide information received from meteorological or seismographic information services, depending on monitoring needs. The data collected are delivered to server 101 through appropriate communication systems that may include, to give just a few examples, local networks, LAN, WAN, Internet, fixed or mobile telephone networks.

In a preferred embodiment of this invention, server 101 is connected to one or more BIM systems 105, each relating to at least one project.

Server 101 also has access to a Blockchain platform 107, where the entire history of the project being monitored (one or more projects) is recorded in a traceable and secure way with corresponding economic quantifications. This structure is by nature shared (and therefore able to be checked by anyone) and unmodifiable. This prevents any attempt at manipulation and makes it possible to place all the economic aspects of a project, from supplier payments to unforeseen costs, just to give a few examples, on a safe and traceable basis. In a preferred embodiment of the present invention, the Blockchain used is that of International Business Machines Corp, but those skilled in the art will easily understand that other platforms or solutions could be used without deviating from the scope of the invention below.

The Central Infrastructure, situated within or controlled by server 101, includes a processing module that receives all data from detectors 103, processes it and integrates it into the BIM system, also acting as a link with Blockchain structure 107.

In a preferred embodiment, server 101 stores and records the processed data in special databases (109). Databases 109 may, for example, include data structures that can manage architectures of even large size (Big Data), with the possible use of Artificial Intelligence (AI) applications.

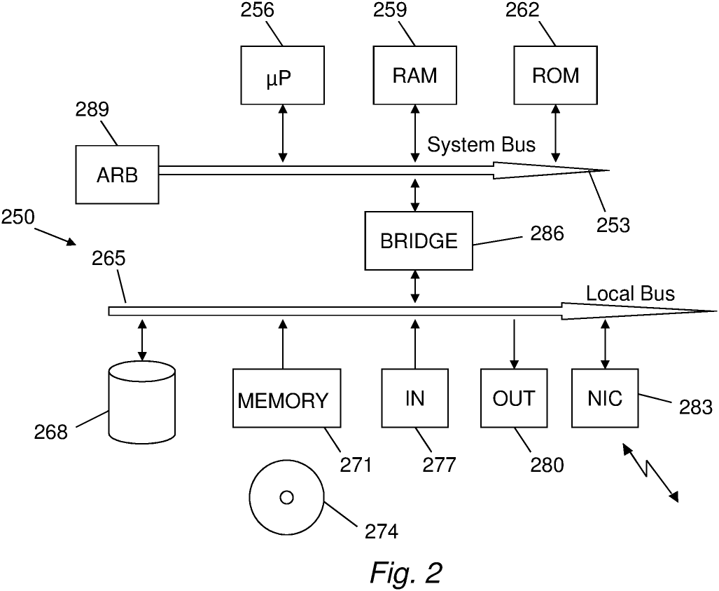

FIG. 2 shows a generic computer used in the system according to the preferred embodiment of the present invention. This generic description includes any equipment with processing capabilities, albeit with different levels of sophistication and functionality (e.g. computers, mobile terminals, servers, network routers, proxy servers). Included in this definition are all devices belonging to the Internet of Things category (also called loTs), i.e. those devices dedicated to specific operations, e.g. construction site machinery, which are also equipped with data processing capability through a microprocessor and are connected to a central system (server), and optionally between them, by means of a computerized network (e.g. Internet). Computer 250 consists of several units that are connected in parallel to a system bus 253. In detail, one or more microprocessors 256 control the operations of the computer; a RAM memory 259 is used directly as a working memory by microprocessors 256, while a ROM memory 262 contains the basic code for initial loading of the system (bootstrap). Several peripheral units are connected to a local bus 265 by means of suitable interfaces. In particular, these peripheral units may include a mass memory consisting of a hard disk drive 271 and a CD-ROM and/or optical disk drive 274 (e.g. DVD or BlueRay) or any other peripheral or memory device external to the computer. In addition, computer 250 may include input devices 277 (e.g. keyboard, mouse, track-point, USB ports) and output devices 280 (e.g. screen, printer, USB ports). A Network Interface Card 283 is used to connect computer 250 to a network. A bridge unit 286 forms the interface between system bus 253 and local bus 265. Each microprocessor 256 and bridge unit 286 can operate as a “master agent” and requires exclusive access to system bus 253 to transmit information. An arbiter 289 handles requests for access to system bus 253, avoiding conflicts between applicants. Similar considerations will apply to systems that are slightly different or based on different network configurations. Other components, in addition to those described, may be present in specific cases and for particular applications (e.g. handheld computers, mobile phones, etc.).

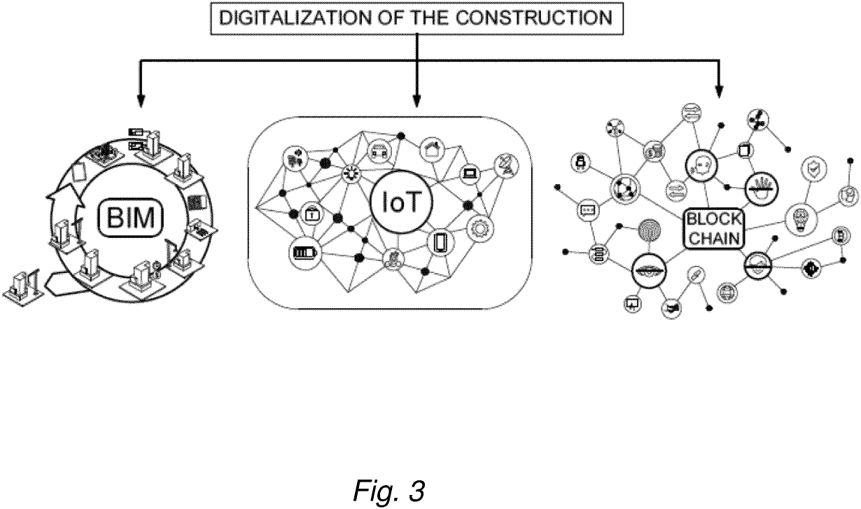

FIG. 3 illustrates a management model according to the present invention; it illustrates the three levels, each of which have their own nodes and interconnections, in which the system is organized: the BIM level, the detector level, via the loT devices, and the Blockchain.

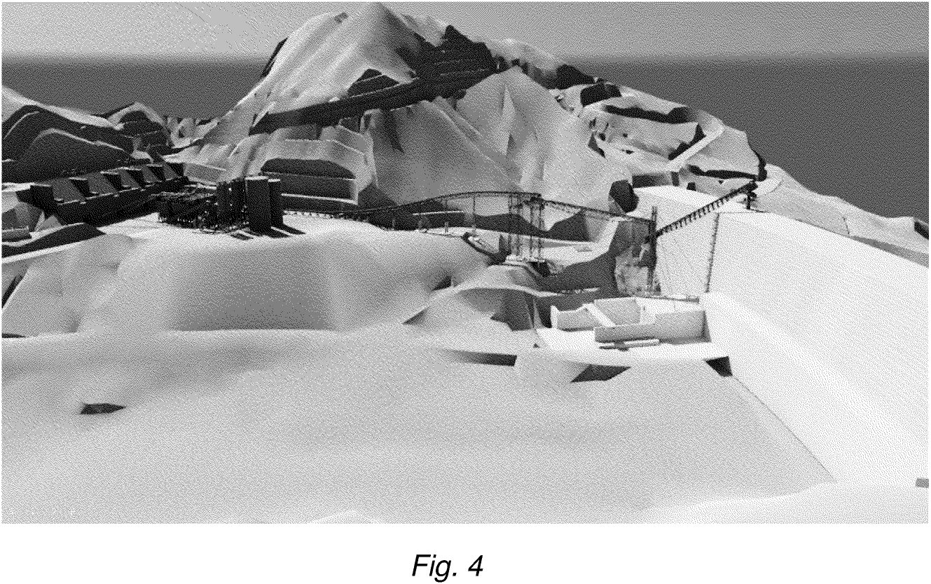

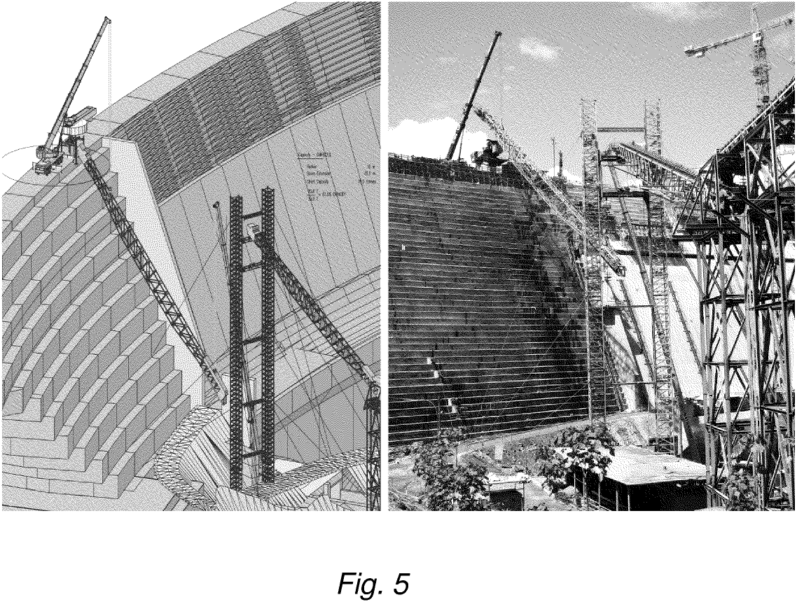

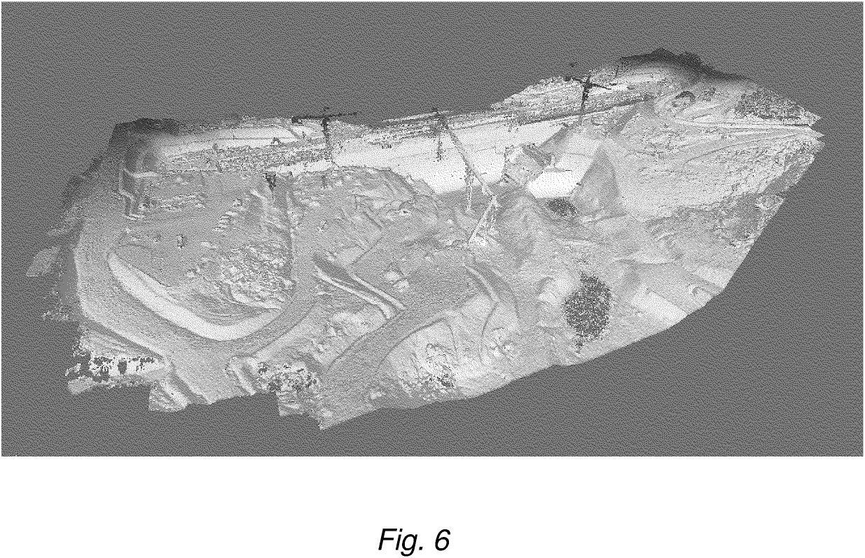

FIGS. 4, 5 and 6 show applications relating to practical examples in which some details of the construction site are represented digitally. These representations are useful to acquire images through, for example, cameras installed on drones, for the purpose of comparing them with other available information.

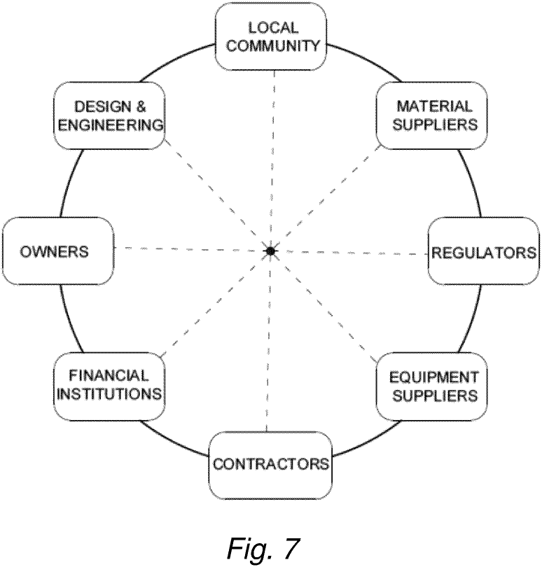

FIG. 7 illustrates a scheme having the architecture of one embodiment of the present invention, with an example based on eight conceptual nodes. The architecture of the Blockchain makes it possible to configure a series of nodes, which for simplicity have currently been imagined to be eight, but obviously could be more or fewer depending on the type of project. For each node it will be possible to profile each category of user, or each user, so that they can access a specific area of the information database. In the example represented in FIG. 7, the “Ecosystem” where a method and system according to a preferred embodiment of the present invention is implemented, includes 8 nodes corresponding to the following categories: Local Community; Material Suppliers; Regulators; Equipment Suppliers; Contractors; Financial Institutions; Owners; Design & Engineering. Sharing of the information ensures that it is unmodifiable and allows it to be used as legally validated data for the processing of smart contracts for all the parties involved in the project.

Causes of force majeure or unforeseen variants will generate updates to the three levels of the structure in real time, so that all are rescheduled if changes are made to the elements making up the project (times, values, contents, methods, etc.).

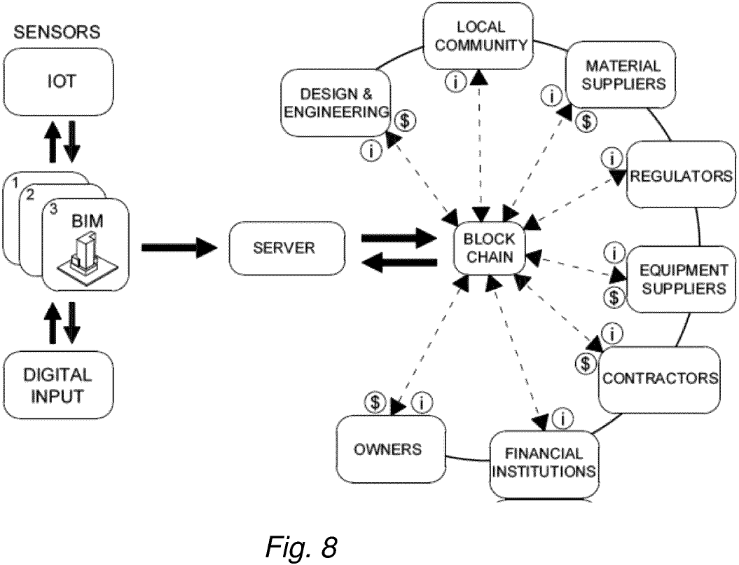

FIG. 8 is representation of an architecture according to a preferred embodiment of the present invention, with the 8-node Ecosystem of FIG. 7. The architecture according to a preferred embodiment of the present invention, as represented in FIG. 8, includes a server which collects IOT data from the construction site and compare them with the BIM project, in order to automatically track the progress and deviation from the baseline. Embedded smart contracts connect the financial transactions to the construction events and everything is certified and trusted through a permissioned Blockchain. The architecture (also defined Platform in the following), represented in FIG. 8, addresses the following needs:
1. Real time project tracking and transparency
2. Realtime financial tracking and payments
3. Contract and regulations data access
4. Trusted bidding process
5. Raw material traceability
6. Project risk management
7. Construction quality
8. Safety & Responsibility

In more details:

1. The real time project tracking and transparency allows the early discovery and understanding of the nature of the delays and highlight mitigation options, enabling the adaptation strategies. In constructions is nowadays crucial to anticipate and react to changes that result from the different players interactions and dependencies: the Platform do this thanks to adaptation tracking and project impact forecasting.

2. Realtime financial tracking and payments: the platform enables the project progress and payment tracking, avoiding the misalignment between budget, BIM, resources and actual forecasting. Financial transactions can be mapped to metrics of quality, quantity, safety and time throughout the project. This increases the reliability of successful project completion and loans repayment. Trusted blockchain data allow payments automation, improving cash flow to contractors and subcontractors, resolving the payment delays sickness; better communication between lenders and clients, as well as their clients, generate a virtuous business environment.

3. Contracts and regulations data access increase the transparency of projects for all participants and the respects of rules and compliance, thanks to more robust and seamless interactions and dependencies between players in all transactions. The real time oversight and notification when contractual obligations are not met and the non-biasedness in oversight of contractual enforcement, reduce dramatically litigation issue and expenses.

4. The bid transparency for all the stakeholders (financial institutions included) regarding project parameters, data needed, resources and other key variables, is mandatory to assure that the awarding process is based on the fair price and the bidding estimates are compatible with budgets and requirements. In this way, the whole ecosystem is aware of the reason why the contract was awarded. All the bidding process can be managed on the Platform, from the assessing reliability of contractors and sub-contractors, based on methods and resources, to discrepancies logging between tender parameters and delivered results.

5. Raw material traceability: real-time Supply chain monitoring and planning, raw material procurement transparency, quality control verification/compliance checking enforce and oversight simultaneously all environmental footprints. This allows to create sustainable and green procurement linked to lender requirements, regulations, and protocols.

6. Project risk management: the automatic verification of misalignment between budget, bid, resources, actual needs and forecasting overrides the critical transactions to BIM and schedule mapping, dramatically reducing construction risk. The platform enables also project time and resources estimation with high precision; it provides material and equipment requirements, availability forecasting in the pre-bid phase, as well as critical transactions identification and tracking.

7. Construction quality: real-time monitoring directly connected to the machines and equipment, bypassing human interference through linked testing data from all sources, including third party, extremely increases quality and detecting immediately difference between project as design and project as executed, as well as the respect of agreed construction standards.

8. Safety & Responsibility: the platform allows to share information about safety and regulations respect on site, among all stakeholders. Project progress and resource tracking are easily accessible to the community being served by the project. Clarity and transparency between parties increase local safety and compliance to environmental protection.

In FIG. 8, the symbol “i” indicates an exchange of information between the server and the node, through the Blockchain, while the symbol “$” indicates a possible financial transaction.

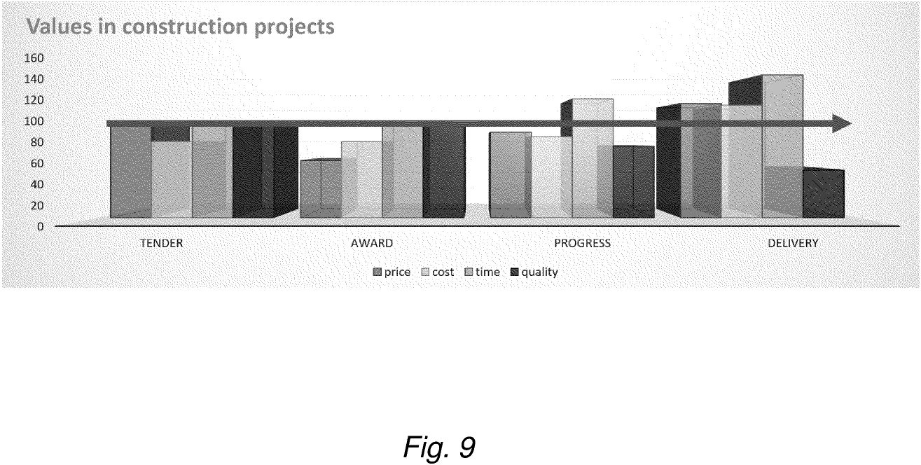

FIG. 9 shows an illustrative graph generated by a system according to a preferred embodiment of the present invention.

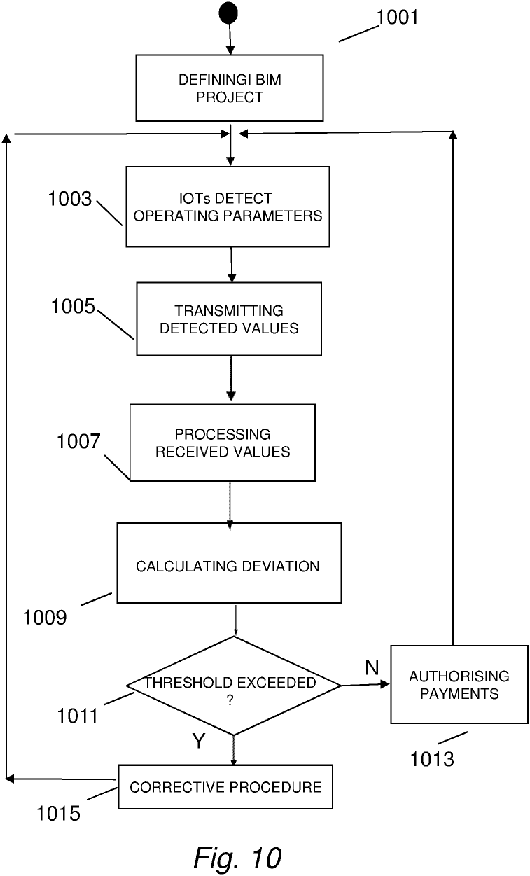

FIG. 10 shows the steps of a method for managing and monitoring the conduct of at least one project according to a preferred embodiment of the present invention. The project, preferably defined and managed by means of a BIM system, comprises a plurality of activities, each having parameters and timing defined in the BIM. The system may also be set up to monitor the conduct of more than one project, each of which will be defined by appropriate parameters and activities. The method is implemented by means of a distributed system comprising a number of detectors 103, connected to a server, each intended to measure at least one operating parameter and transmit the value of the measured operating parameter to a server 101 at predetermined intervals. Detectors 103 include a possible wide variety of devices, at least some of which will be equipped with processing capabilities, and all of which are connected to the server. The method, as illustrated in step 1001, requires as a prerequisite that a project (or several projects) be defined, for example by means of a BIM system (or model) that associates a list of activities with the relative parameters and timings for each project. The project includes also the definition of agreed of milestones with associated partial payment, the completion of each milestone being the requisite for authorizing the related partial payment. Detectors 103 are physically located on the site where the project is conducted or have links to that geographical site (e.g. a service that detects meteorological or seismographic data). In any event, they collect data about one or more parameters relating to one or more activities (step 1003). Possible types of detectors 130 also include fixed or mobile devices for the acquisition of images (e.g. mounted on drones). During conduct of the activities making up the project (or each project), detectors 103 send information about the various parameters associated with them (step 1005) at predefined intervals that can obviously be customized and modified, even while work is in progress. Each activity will have one or more detectors 103 associated with it, just as each detector will be associated with one or more activities in a project. According to a preferred embodiment of this invention, detectors 103 mostly comprise so-called loT (Internet of Things) devices. The details of how this detection and transmission takes place and the times and frequencies of data transmission between the sensors and the server may change according to specific needs. In step 1007, by means of a processing module, server 101 processes the values of the parameters received from the plurality of sensors 103, and determines a deviation from the expected value as defined by the BIM predefined milestones (see step 1009) for each parameter and for the project in general. According to a preferred embodiment of the present invention, the server is connected to a Blockchain system to create and update traceable and non-modifiable documentation for all the activities carried out in the project. The connection with the Blockchain may also be made directly from detectors 103 and may interact with the BIM system. If the server determines an overall value and/or a specific value for a single activity to be deviant (step 1011), a corrective procedure can be put in place (step 1015). Otherwise, the system determines that the milestone associated to the monitored activity is completed and the payment related to the milestone can be authorized by the server (step 1013): the collection and sending of information can continue, returning to step 1103.

In practice, the details of execution can in any event be varied in an equivalent manner with regard to the individual construction elements described and illustrated and the nature of the materials indicated, without deviating from the concept of the solution adopted, and therefore remaining within the limits of protection conferred by the present patent. A person skilled in the art would be able to make many changes to the solution described above in order to meet local or specific requirements. In particular it should be clear that, although implementing details have been provided for one or more preferred embodiments, omissions, substitutions or variations of some specific features or steps of the method described may be made on account of design or implementation requirements.

By way of example, the hardware structures may take on a different appearance or include different modules; the term computer includes any apparatus (e.g. telephones, PDAs, machines and sensors of any type) with the processing capacity to run software programs or parts of them. Programs may be structured differently or implemented in any form. In the same way, memories may take multiple forms or be replaced by equivalent units (not necessarily comprising tangible media). Programs may take any suitable form to perform their functions and may be written in any programming language or presented in the form of software, firmware or microcode, both object code and source code. The programs themselves may be stored on any type of medium, provided that it can be read by computer; by way of example, the media may be: hard disks, removable disks (e.g. CD-ROMs, DVDs or Blue Ray Disks), tapes, cartridges, wireless connections, networks, telecommunication waves; the media may for example be electronic, magnetic, optical, electromagnetic, mechanical, infrared or semiconductor. In any event, the solution according to this invention may be implemented by means of software, hardware (also incorporated in chips or semiconductor materials) or a combination of hardware and software.

The principle whereby monitoring the performance of activities forms part of a structured process applies to any field in which there is a need to keep the progress of activities under control and ensure compliance between actually measured values and those foreseen in advance, provided that the process generating these values can be monitored and the values can be measured.

1. Method for managing and monitoring the execution of at least one project comprising a plurality of activities, by means of a distributed system comprising a plurality of detectors connected with a server , each of the plurality of detectors being adapted to measure at least one operating parameter related to one of the plurality of activities and to transmit the value of the at least one measured operating parameter at predetermined time intervals to the server , the method comprising the steps of:
maintaining, for each project, in a database accessible from the server , a smart contract defining a list of activities, each activity having a plurality of associated operating parameters and for each associated operating parameter an expected value based on the time elapsed since the beginning of the activity, the smart contract defining the payments to be authorized when the expected values are reached, each of the operating parameters being associated with at least one of the plurality of sensors ;
processing, in a traceable and secure way, by the server the values of the parameters received from the plurality of sensors and calculating for each parameter a deviation from the expected value;
determining by the server a value representative of the total deviation with respect to the plurality of expected values;
responsive to a predetermined threshold being exceeded by the value representative of the total deviation, executing a predetermined corrective action procedure; or
responsive to the predetermined threshold not being exceeded by the value representative of the total deviation, authorizing the payment associated to the expected values.

2. The method for managing and monitoring execution according to claim 1, wherein processing in a traceable and secure way is performed by means of a Blockchain.

3. The method for managing and monitoring execution according to claim 1 wherein the smart contract defines at least one milestone associated to each of the plurality of activities, each milestone being associated to at least one financial transaction, and wherein the method further comprises:
monitoring the real time progress of the plurality of activities to determine whether a milestone is reached;
responsive to a milestone being reached, authorizing the at least one associated financial transaction.

4. The method for managing and monitoring execution according to claim 1 wherein the plurality of detectors comprises at least one loT device.

5. The method for managing and monitoring execution according to claim 1 of the wherein the plurality of detectors comprises at least one image acquisition device.

6. The method for managing and monitoring execution according to claim 5, wherein the at least one image acquisition device is installed on a drone.

7. The method for managing and monitoring execution according to claim 1 of the wherein the plurality of detectors comprises at least one personal wearable device.

8. The method for managing and monitoring execution according to claim 1 of the wherein the plurality of detectors comprises at least one device capable of providing meteorological and/or seismographic information of a geographical area linked to the at least one project.

9. The method for managing and monitoring execution according to claim 1 of the wherein the activities of the at least one project are defined by means of a Building Information Modeling (BIM) system.

10. The method for managing and monitoring execution according to claim 1 wherein the server and/or at least one of the detectors are connected and exchange information with a Blockchain system.

11. A computer program adapted to perform a method for managing and monitoring the execution of at least one project comprising a plurality of activities, according to claim 1 when the program is executed on a data processing system.

12. A distributed system comprising one or more components suitable for implementing a method for managing and monitoring the execution of at least one project comprising a plurality of activities, according to claim 1.
